(19) United States
(12) Patent Application Publication
(10) Pub. No.: US 2023/0316078 A1
(43) Pub. Date: Oct. 5, 2023

(54) MODEL TRAINING METHOD AND APPARATUS, DEVICE, STORAGE MEDIUM AND PROGRAM PRODUCT

(71) Applicant: TENCENT TECHOLOGY (SHENZHEN) COMPANY LIMITED, Shenzhen (CN)

(72) Inventors: Tao HUANG, Shenzhen (CN); Ruipeng LI, Shenzhen (CN)

(73) Assignee: TENCENT TECHOLOGY (SHENZHEN) COMPANY LIMITED, Shenzhen (CN)

(21) Appl. No.: 18/327,304

(22) Filed: Jun. 1, 2023

Related U.S. Application Data
(63) Continuation of application No. PCT/CN2022/127509, filed on Oct. 26, 2022.

(30) Foreign Application Priority Data
Nov. 26, 2021 (CN) 20211416769.8

(51) Int. Cl. G06N 3/08

(52) U.S. Cl. CPC G06N 3/08

(57) ABSTRACT

Embodiments of this application disclose a model training method and related apparatuses in the field of artificial intelligence. The method includes: acquiring at least one to-be-detected indicator data in target business scenarios; specific to each to-be-detected indicator data, determining, by a deep neural network model, uncertainty of a detection result corresponding to the to-be-detected indicator data, where the uncertainty is used for representing the degree of reliability of the detection results, and the detection results are determined by the deep neural network model according to the to-be-detected indicator data; selecting reference indicator data from the at least one to-be-detected indicator data according to the uncertainty of the detection result corresponding to each of the at least one to-be-detected indicator data, and acquiring label detection results corresponding to the reference indicator data; and training the deep neural network model based on the reference indicator data and their corresponding label detection results, so as to obtain a target indicator detection model applicable to the target business scenarios. The method can reduce the cost for training the indicator detection model.

### CROSS-REFERENCES TO RELATED APPLICATIONS

This application is a continuation of International Application No. PCT/CN2022/127509, filed with the China National Intellectual Property Administration on Oct. 26, 2022, which claims priority to Chinese Patent Application No. 202111416769.8, filed with China National Intellectual Property Administration on Nov. 26, 2021, the disclosures of which are incorporated by reference herein in their entireties.

### FIELD

This application relates to the technical field of artificial intelligence, and in particular relates to model training.

### BACKGROUND

Along with popularization of the cloud native technology, a microservices architecture of a large online system effectively promotes efficient implementation and independent deployment of network applications. Under normal conditions, microservices under the microservices architecture have a complex invoke relationship, and faults of any microservice may cause fault cascade, influencing the quality of services provided by the microservices architecture. To avoid the situations, operation and maintenance personnel needs to closely monitor key performance indicators (KPIs) of each microservice, and immediately intervene for debugging once the KPI is abnormal.

In recent years, a large number of indicator detection methods come forth in the related art, such as a probabilistic-based indicator detection method, a distance-based indicator detection method, a domain-based indicator detection method, and a reconstruction-based indicator detection method. These indicator detection methods need to adopt a machine learning algorithm to train a model for detecting whether indicators are abnormal or not, and then utilize the trained model to analyze and process current observed indicator data, so as to detect whether the indicator data is abnormal or not.

However, the above indicator detection methods commonly have the problem of labeled sample missing, that is, in many cases, the data volume of indicators required to be detected is extremely huge in a practical production environment, and labeling the large-scale indicators requires extremely high label cost, which is hard to implement. If only small-scale indicators are labeled and labeled data is utilized for training an indicator detection model, accuracy of detecting all the indicators by the trained indicator detection model is hard to guarantee. It can be seen that how to train an indicator detection model with excellent performance has become a problem urgent to be solved at present.

### SUMMARY

Embodiments of the present disclosure provide a model training method and related apparatuses, a device, a storage medium and a program product, which can train an indicator detection model with excellent performance with low label cost.

An aspect of the present disclosure relates to a method for optimizing training a deep neural network model. The method may include acquiring at least one indicator data; determining, by the deep neural network model, respective uncertainty of a detection result corresponding to respective indicator data among the at least one indicator data, wherein the respective uncertainty indicates a respective degree of reliability of the detection results; selecting reference indicator data from the at least one indicator data based on the respective uncertainty of the detection result, wherein an uncertainty of the detection result corresponding to the reference indicator data is higher than the respective uncertainty of the detection result corresponding to non-reference indicator data among the at least one indicator data; acquiring label detection results corresponding to the reference indicator data; and obtaining a trained target indicator detection model based on training the deep neural network model based on the reference indicator data and the label detection results corresponding to the reference indicator data.

An aspect of the present disclosure relates to an apparatus for optimizing training a deep neural network model. The apparatus may include at least one first memory configured to store a first program code; and at least one first processor configured to read the first program code and operate as instructed by the first program code. The program code may include first acquiring code configured to cause the at least one first processor to acquire at least one indicator data; first determining code configured to cause the at least one first processor to determine, by the deep neural network model, respective uncertainty of a detection result corresponding to respective indicator data among the at least one indicator data, wherein the respective uncertainty indicates a respective degree of reliability of the detection results; first selecting code configured to cause the at least one first processor to select reference indicator data from the at least one indicator data based on the respective uncertainty of the detection result, wherein an uncertainty of the detection result corresponding to the reference indicator data is higher than the respective uncertainty of the detection result corresponding to non-reference indicator data among the at least one indicator data; second acquiring code configured to cause the at least one first processor to acquire label detection results corresponding to the reference indicator data; and first obtaining code configured to cause the at least one first processor to obtain a trained target indicator detection model based on training the deep neural network model based on the reference indicator data and the label detection results corresponding to the reference indicator data.

An aspect of the present disclosure relates to a non-transitory computer-readable medium storing instructions that, when executed by a processor, cause the processor to acquire at least one indicator data; determine, by the deep neural network model, respective uncertainty of a detection result corresponding to respective indicator data among the at least one indicator data, wherein the respective uncertainty indicates a respective degree of reliability of the detection results; select reference indicator data from the at least one indicator data based on the respective uncertainty of the detection result, wherein an uncertainty of the detection result corresponding to the reference indicator data is higher than the respective uncertainty of the detection result corresponding to non-reference indicator data among the at least one indicator data; acquire label detection results corresponding to the reference indicator data; and obtain a trained target indicator detection model based on training the deep neural network model based on the reference indicator data and the label detection results corresponding to the reference indicator data.

### BRIEF DESCRIPTION OF THE DRAWINGS

FIG. 1 is a schematic diagram of an application scenario of a model training method according to an embodiment of the present disclosure.

FIG. 2 is a schematic flowchart of the model training method according to an embodiment of the present disclosure.

FIG. 3 is a schematic diagram of data distribution according to an embodiment of the present disclosure.

FIG. 4 is a schematic diagram of another data distribution according to an embodiment of the present disclosure.

FIG. 5 is a schematic diagram of an implementation architecture for the model training method according to an embodiment of the present disclosure.

FIG. 6 is a schematic diagram of a test result according to an embodiment of the present disclosure.

FIG. 7 is a schematic structural diagram of a model training apparatus according to an embodiment of the present disclosure.

FIG. 8 is a schematic structural diagram of another model training apparatus according to an embodiment of the present disclosure.

FIG. 9 is a schematic structural diagram of a terminal device according to an embodiment of the present disclosure.

FIG. 10 is a schematic structural diagram of a server according to an embodiment of the present disclosure.

### DETAILED DESCRIPTION

In order to enable a person skilled in the art to better understand the solutions of the present disclosure, the following clearly and completely describes the technical solutions of embodiments of the present disclosure with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the scope of protection of the present disclosure.

The terms such as “first”, “second”, “third”, and “fourth” (if any) in the description and claims of the present disclosure and in the above accompanying drawings are used for distinguishing similar objects but not necessarily used for describing any particular order or sequence. It is to be understood that such used data is interchangeable where appropriate so that the embodiments of the present disclosure described here can be implemented in an order besides those illustrated or described here. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, product, or device.

The solutions provided by the embodiments of the present disclosure relate to the machine learning technology of artificial intelligence, and are specifically explained through following embodiments:

In the related art, if there is a need to train an indicator detection model with excellent performance in a certain business scenario, all types of indicator data in the business scenario is generally required to be labeled, and then model training is performed based on the labeled data. However, in practical application, there are many types of indicators required to be monitored in most of business scenarios, and labeling all the types of indicator data requires extremely high label cost, which is hard to implement. If only small-scale indicator data are labeled and labeled data is utilized for training a model, accuracy of detecting all the indicators by the trained model is hard to guarantee.

In order to solve the above problems in the related art, an embodiment of the present disclosure provides a model training method, which can guarantee that a trained indicator detection model has excellent performance in a specific business scenario only with low label cost.

Specifically, in the model training method provided by the embodiment of the present disclosure, at least one to-be-detected indicator data in target business scenarios is first acquired. Then, specific to each to-be-detected indicator data, a deep neural network model determines, uncertainty of a detection result corresponding to the to-be-detected indicator data according to the to-be-detected indicator data, where the uncertainty is used for representing the degree of reliability of the detection results, and the detection results are determined by the deep neural network model according to the to-be-detected indicator data. Then, reference indicator data is selected from the at least one to-be-detected indicator data according to the uncertainty of the detection result corresponding to each of the at least one to-be-detected indicator data, and label detection results corresponding to the reference indicator data are acquired. Finally, optimized training is performed on the deep neural network model based on the reference indicator data and their corresponding label detection results, so as to obtain a target indicator detection model applicable to the target business scenarios.

The above model training method creatively puts forward a mode of fusing deep learning and active learning to train the indicator detection model. Specifically, the method first utilizes the deep neural network model trained through the deep learning for determining the uncertainty of the detection results corresponding to the various to-be-detected indicator data. Then, feedback samples for the active learning are selected from the various to-be-detected indicator data according to the uncertainty of the detection results corresponding to the various to-be-detected indicator data. Then, the active learning is performed on the deep neural network model through the selected feedback samples to obtain the target indicator detection model applicable to the target business scenarios. Due to the uncertainty of the detection results corresponding to the to-be-detected indicator data generated by the deep neural network model, the degree of reliability of the detection results can be reflected, that is, the processing capacity of the deep neural network model on the to-be-detected indicator data can be reflected, and if the uncertainty is high, it is indicated that the processing capacity of the deep neural network model on the to-be-detected indicator data is poor, and it is hard to accurately detect whether the to-be-detected indicator data is abnormal or not. On that basis, the indicator data difficult for the deep neural network model to accurately detect can be selected from the to-be-detected indicator data according to the uncertainty of the detection result corresponding to each of the at least one to-be-detected indicator data in the embodiment of the present disclosure, and the indicator data and their corresponding label detection results are utilized as the feedback samples. The kind of feedback samples are high in quality, and the performance of the deep neural network model in the target business scenario can be rapidly improved only by utilizing a small number of the kind of feedback samples for training the deep neural network model, thereby achieving the effect of training the indicator detection model with the excellent performance with the low label cost.

The deep neural network model in the embodiment of the present disclosure is a model with a basic indicator detection capability, and when the deep neural network model is trained, any sample for training the indicator detection model can be used for training the deep neural network model. Under normal conditions, in order to reduce cost for training the deep neural network model, a low-cost training sample can be acquired and adopted to train the deep neural network model. For example, a current existing general training sample set (i.e., a basic training sample set generally used for training the indicator detection model) is adopted to train the deep neural network model; and for another example, historical indicator data and their corresponding historical detection results in the business scenario are adopted as training samples to train the deep neural network model, etc. In other words, the deep neural network model in the embodiment of the present disclosure is a training basis for the target indicator detection model required to be trained. In practical application, the requirement for the processing performance of the deep neural network model is low, and thus, training the deep neural network model with too much training cost is unnecessary as long as it is guaranteed that the deep neural network model has the detection capability for the indicator data, and can output the uncertainty of the detection results determined by the deep neural network model.

It is to be understood that the model training method provided by the embodiment of the present disclosure can be executed by a computer device with a data processing capacity, and the computer may be a terminal device or a server. The terminal device specifically may be a mobile phone, a computer, an intelligent voice interaction device, an intelligent household electrical appliance, a vehicle-mounted terminal, an aircraft, etc. The server specifically may be an application server or a Web server, and during practical deployment, may be a dedicated server or a cluster server or a cloud server composed of a plurality of physical servers. The indicator data, the detection results of the indicator data, etc. involved in the embodiment of the present disclosure can be stored on a blockchain.

To facilitate understanding of the model training method provided by the embodiment of the present disclosure, an executive body for the model training method being the server is adopted as an example below to illustratively introduce an application scenario of the model training method.

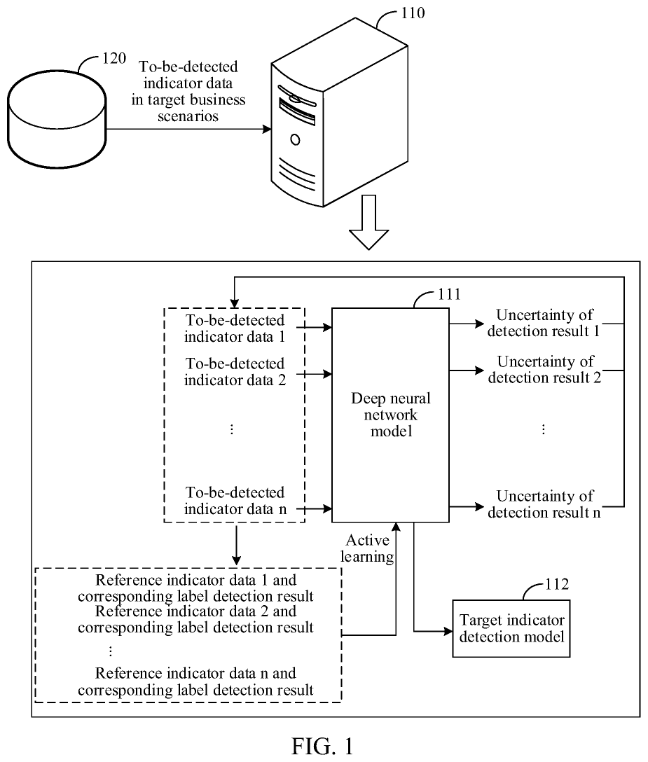

Refer to FIG. 1, and FIG. 1 is a schematic diagram of an application scenario of a model training method according to an embodiment of the present disclosure. As shown in FIG. 1, the application scenario includes a server 110 and a database 120, the server 110 can invoke, by a network, data from the database 120, or the database 120 may also be integrated in the server 110. The server 110 may be a backend server in a target business scenario, and is configured to execute the model training method provided by the embodiment of the present disclosure so as to train a target indicator detection model for detecting whether indicator data in the target business scenario is abnormal or not. The database 120 is configured to store to-be-detected indicator data in the target business scenario.

In practical application, the server 110 may invoke at least one to-be-detected indicator data in the target business scenario from the database 120. The target business scenario herein may be any scenario with an indicator detection demand, such as a microservice monitoring scenario, a physical entity (e.g., a physical device in a machine room) monitoring scenario, a logical entity (e.g., a processing module in backend deployment) monitoring scenario, a network topology monitoring scenario, and a log data monitoring scenario. The to-be-detected indicator data acquired herein may be data of any indicator required to be monitored in the target business scenario, such as monitoring data of a central processing unit (CPU) of the server in the microservice monitoring scenario. When the server 110 acquires a plurality of to-be-detected indicator data, the plurality of to-be-detected indicator data may be data under the same indicator, or data under multiple indicators, which is not limited by the present disclosure.

After the server 110 acquires the at least one to-be-detected indicator data in the target business scenario, specific to each to-be-detected indicator data, the server 110 may adopt a pre-trained deep neural network model 111 to process the to-be-detected indicator data, so as to obtain detection results corresponding to the to-be-detected indicator data, and uncertainty of the detection results. The deep neural network model 111 is a model pre-trained through deep learning for detecting whether the indicators are abnormal or not, and has a basic indicator detection capability, but accuracy of the generated detection results may be not high in the target business scenario, that is, adaptability of the deep neural network model in the target business scenario may be low. In addition, the deep neural network model can also generate the uncertainty of the detection results generated by the same, the uncertainty can reflect the degree of reliability of the detection results, that is, the processing capacity of the deep neural network model on the to-be-detected indicator data and whether the deep neural network model can accurately detect the to-be-detected indicator data or not can be reflected.

Through the above processing, after the server 110 finishes detection processing specific to each acquired to-be-detected indicator data, and determines the uncertainty of the detection results corresponding to the to-be-detected indicator data, the to-be-detected indicator data corresponding to the detection result high in uncertainty can be selected from the to-be-detected indicator data according to the uncertainty of the detection results corresponding to the to-be-detected indicator data to serve as reference indicator data, and label detection results corresponding to the reference indicator data are acquired, which can accurately reflect whether their corresponding reference indicator data is abnormal or not.

Then, the server 110 may perform active learning on the above deep neural network model based on the reference indicator data and their corresponding label detection results, that is, optimized training is performed on the deep neural network model through the indicator data hard to accurately detect by the deep neural network model, and thus, a target indicator detection model 112 applicable to the target business scenario is obtained and can accurately detect whether the indicator data in the target business scenario is abnormal or not. The selected reference indicator data is the indicator data hard to accurately detect by the deep neural network model, and has a great assistance function on improving performance of the deep neural network model, that is, the indicator data has a high value for the optimized training of the deep neural network model. In practical application, only a small amount of the kind of indicator data and their corresponding label results are utilized for optimized training of the deep neural network model, and thus, the deep neural network model can be rapidly improved in performance so as to be applicable to indicator detection in the target business scenario.

It is to be understood that the application scenario shown in FIG. 1 is only an example. In practical application, the model training method provided by the embodiment of the present disclosure may also be applied to other scenarios, for example, the server 110 can directly collect the to-be-detected indicator data from related monitoring points in the target business scenario, and thus, the applicable application scenario of the model training method provided by the embodiment of the present disclosure is not limited.

The model training method provided by the present disclosure is introduced in detail through a following method embodiment.

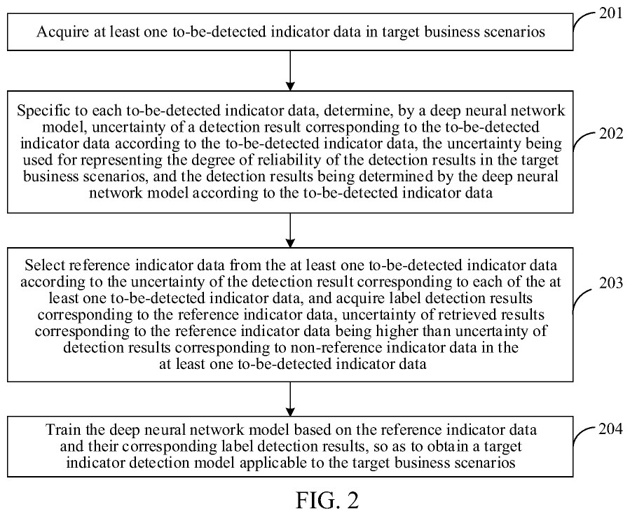

Refer to FIG. 2, and FIG. 2 is a schematic flowchart of a model training method according to an embodiment of the present disclosure. To facilitate description, in the following embodiment, an executive body for the model training method being a server is still adopted as an example for introduction. As shown in FIG. 2, the model training method includes the following operations:

Operation 201: Acquire at least one to-be-detected indicator data in target business scenarios.

Before the server trains a target indicator detection model for monitoring whether the indicator data in the target business scenarios is abnormal or not, the at least one to-be-detected indicator data in the target business scenarios is required to be first acquired, so as to select training samples applicable to training the target indicator detection model from the acquired at least one to-be-detected indicator data. It is to be understood that under normal conditions, to perform more sufficient training on the target indicator detection model, the server can acquire a plurality of (i.e., at least two) to-be-detected indicator data.

The target business scenario in the embodiment of the present disclosure may be any scenario with an indicator monitoring demand, that is, if whether indicator data in a certain business scenario is abnormal or not is required to be monitored, the business scenario may be regarded as the target business scenario.

Exemplarily, the target business scenario in the embodiment of the present disclosure may include any one of followings: the microservice monitoring scenario, the physical entity monitoring scenario, the logical entity monitoring scenario, the network topology monitoring scenario, or the log data monitoring scenario. The microservice monitoring scenario refers to an application scenario where KPIs of microservices under a microservices architecture are monitored. The physical entity monitoring scenario refers to an application scenario where various indicators of hardware devices in a machine room are monitored. The logical entity monitoring scenario refers to an application scenario where various indicators of virtual functional modules in a software architecture are monitored. The network topology monitoring scenario refers to an application scenario where various communication indicators in a network communication architecture are monitored. The log data monitoring scenario refers to an application scenario where various log data generated in a production process is monitored. The main purpose of monitoring whether the indicator data in the above target business scenario is abnormal or not is to judge whether faults exist in the business scenario or not in time so that related operation and maintenance personnel can perform timely intervention and debugging.

It is to be understood that besides the above scenarios, the target business scenario in the embodiment of the present disclosure may further include any other scenarios needing indicator monitoring, such as any artificial intelligence for IT operations (AIOps) intelligent operation and maintenance scenario, and the target business scenario is not limited in the embodiment of the present disclosure.

The to-be-detected indicator data in the embodiment of the present disclosure may be observation data of any indicator required to be monitored in the target business scenario. For example, when the target business scenario is the microservice monitoring scenario, the to-be-detected indicator data may be any KPI value of the microservice. In the embodiment of the present disclosure, when the server acquires a plurality of to-be-detected indicator data, the plurality of to-be-detected indicator data may be a plurality of observation data of the same indicator in the target business scenario, or a plurality of observation data of multiple indicators in the target business scenario, and indicators to which the acquired to-be-detected indicator data belong are not limited by the present disclosure.

In practical application, when the server acquires the to-be-detected indicator data in the target business scenario, the to-be-detected indicator data can be directly collected from related nodes in the target business scenario. For example, when the target business scenario is the physical entity monitoring scenario, the server can directly collect data of indicators required to be monitored from hardware devices required to be monitored. In addition, the server may also collect the to-be-detected indicator data from databases related to the target business scenario. For example, the various to-be-detected indicator data in the target business scenario can be transmitted into the corresponding databases, and correspondingly, the server can collect the to-be-detected indicator data from the databases. Of course, in practical application, the server may also adopt other manners to acquire the plurality of to-be-detected indicator data in the target business scenario, and the manner for acquiring the to-be-detected indicator data by the server is not limited by the present disclosure.

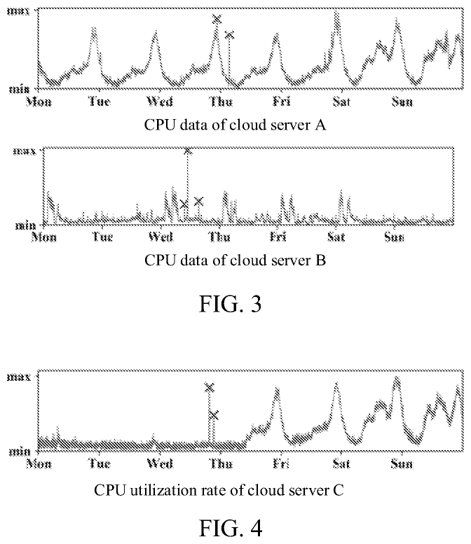

In some embodiments, the method provided by the embodiment of the present disclosure may also be applied to a cross-business scenario, that is, the embodiment of the present disclosure can be used for training a target indicator detection model applicable to multiple business scenarios at the same time. In the related art, it is usually hard for an indicator detection model trained based on an unsupervised learning manner to have a cross-business scenario expansion capability. For example, as shown in FIG. 3, a cloud server A and a cloud server B have differences in CPU data distribution mode, and in the situation, it is difficult for a model trained based on the unsupervised learning manner for monitoring CPU data of the cloud server A to monitor whether CPU data of the cloud server B is abnormal or not. The embodiment of the present disclosure utilizes the characteristic that a deep learning model has a rich representational capacity so as to train the target indicator detection model with the cross-business scenario expansion capability.

When the server trains the target indicator detection model with the cross-business scenario expansion capability, a plurality of target business scenarios (i.e., at least two) can be determined. Then, specific to each target business scenario, at least one to-be-detected indicator data in the target business scenario is acquired. Exemplarily, assuming that the server needs to train the target indicator detection model for monitoring the CPU data of the cloud server A and the CPU data of the cloud server B at the same time, the server may regard a scenario for monitoring the CPU data of the cloud server A and a scenario for monitoring the CPU data of the cloud server B as the target business scenarios. Then, at least one to-be-detected indicator data in each target business scenario is acquired.

It is to be understood that an arbitrary number (greater than or equal to 2) of the target business scenarios may be determined by the server, an arbitrary quantity (greater than or equal to 1) of the to-be-detected indicator data may be acquired by the server specific to each target business scenario, and neither the number of the determined target business scenarios nor the quantity of the acquired to-be-detected indicator data is limited by the present disclosure.

Operation 202: Specific to each to-be-detected indicator data, determine, by a deep neural network model, uncertainty of a detection result corresponding to the to-be-detected indicator data according to the to-be-detected indicator data. The uncertainty is used for representing the degree of reliability of the detection results in the target business scenarios, and the detection results are determined by the deep neural network model according to the to-be-detected indicator data.

After the server acquires the plurality of to-be-detected indicator data in the target business scenarios, the pre-trained deep neural network model can be utilized for detecting and processing each to-be-detected indicator data, so as to obtain the detection result corresponding to the to-be-detected indicator data, and the uncertainty of the detection result. Specifically, specific to each to-be-detected indicator data, the server can input the to-be-detected indicator data into the pre-trained deep neural network model, the deep neural network model analyzes and processes the to-be-detected indicator data, then correspondingly outputs the detection result corresponding to the to-be-detected indicator data and can also determine the uncertainty corresponding to the detection result.

The above deep neural network (DNN) model is a neural network model trained by pre-adopting a deep learning algorithm based on a cold start sample, and the deep neural network model has a basic capability of detecting whether the indicator data is abnormal or not, and can output the uncertainty of the detection results thereof. The cold start sample herein may be any sample for training the indicator detection model. For example, the cold start sample may be a current existing general-purpose indicator detection model training sample, or historical indicator data and its corresponding historical detection result, where the historical indicator data specifically may be indicator data historically generated in the target business scenario, or indicator data historically generated in other business scenarios, which is not limited by the present disclosure. Under normal conditions, to reduce the model training cost, the low-cost indicator detection model training sample can be selected to be acquired as the above cold start sample, thereby saving the training cost of the deep neural network model in the deep learning stage as much as possible.

The detection results corresponding to the above to-be-detected indicator data are results used for representing whether the to-be-detected indicator data is abnormal or not. Exemplarily, the detection results corresponding to the to-be-detected indicator data may be abnormality scores of the to-be-detected indicator data, and the abnormality score being higher indicates that the possibility of abnormality of the to-be-detected indicator data is higher. Of course, the detection results corresponding to the to-be-detected indicator data may be represented in other forms, and the representation form of the detection results corresponding to the to-be-detected indicator data is not limited by the present disclosure.

In addition, the uncertainty of the detection results corresponding to the to-be-detected indicator data is used for presenting the degree of reliability of the detection results, the degree of reliability may also be understood as credibility, and the uncertainty of the detection result being higher indicates that the detection result is less credible. Correspondingly, the uncertainty can also represent the processing capability of the deep neural network model on the to-be-detected indicator data. The uncertainty being high indicates that the processing capacity of the deep neural network model on the to-be-detected indicator data is poor, and it is hard to accurately detect whether the to-be-detected indicator data is abnormal or not. On the contrary, the uncertainty being low indicates that the processing capacity of the deep neural network model on the to-be-detected indicator data is high, and whether the to-be-detected indicator data is abnormal or not can be accurately detected.

The core idea of the embodiment of the present disclosure is to combine advantages of deep learning and advantages of active learning, and train the indicator detection model applicable to the specific business scenario based on the deep learning and active learning fused idea. The deep learning has the advantages that as long as label samples exist, a deep neural network model trained based on a supervised learning manner can represent abnormality preference in different business scenarios, and the embodiment of the present disclosure introduces the advantages of the deep learning into the solutions of the present disclosure by pre-training the deep neural network model. The active learning has the advantages that the model performance of the trained model can be rapidly improved by learning and updating the model with a small number of training samples with labels, and the embodiment of the present disclosure screens the reference indicator data from the acquired to-be-detected indicator data and performs the active learning on the deep neural network model based on the screened reference indicator data to introduce the advantages of the active learning into the solutions of the present disclosure.

However, in view of practical technology implementation, using the deep learning model in the active learning environment is difficult. Specifically, an acquisition function of the active learning is required to depend on model uncertainty, but in most situations, it is hard for the deep learning model to represent the model uncertainty. For the above problem, the embodiment of the present disclosure provides a solution. That is, a Gaussian process is simulated by random dropout of neuron connections, and then, the detection results of the deep learning model and the uncertainty of the detection results are estimated based on the Gaussian process. The solution is respectively introduced in detail below.

In the above solution, the above deep neural network model is a random dropout neural network model which may also be called an Mc Dropout-based deep neural network model in the embodiment of the present disclosure. When running, the random dropout neural network model can randomly drop inside neuron connections based on a preset dropout ratio. When the uncertainty of the detection results corresponding to the to-be-detected indicator data is determined based on the random dropout neural network model, multi-time neural network forward propagation can be performed on the to-be-detected indicator data through the random dropout neural network model, and thus, detection results corresponding to the multi-time forward propagation are obtained. Then, the uncertainty of the detection results corresponding to the to-be-detected indicator data is determined according to the detection results corresponding to the multi-time forward propagation.

For a neural network with any depth and nonlinear activation function, applying Mc Dropout between weighted layers is mathematically equivalent to approximation of a deep Gaussian process. In more detail, an L-layer deep neural network model is given, where an i^{th}-layer neuron connection weight matrix may be denoted by Wᵢ, the size of the weight matrix is Kᵢ×Kᵢ₋₁, ω={Wᵢ|i=1, 2 . . . L} may be adopted in the embodiment of the present disclosure to represent parameters of the L-layer deep neural network model, an input set and an output set of the deep neural network model are respectively denoted by X and Y, and observation output corresponding to each input element xᵢ in the input set X is denoted by yᵢ. A formula for calculating a predicted probability distribution of observation output y corresponding to a new input element x based on a Gaussian process model is shown in a following formula (1):

p(y|x,X,Y)=∫p(y|x,ω)p(ω|X,Y)dω (1)

Where p(ω|X,Y) denotes a real posteriori distribution of model parameters, the distribution is actually hard to acquire, the embodiment of the present disclosure randomly drops neuron connections in the neural network, such that the parameter w follows bernoulli distribution q(ω), on that basis, the real posterior distribution p(ω|X,Y) of the model parameters is approximately estimated, and a formula of q(ω) is defined by a following formula (2):

Wᵢ=Mᵢ·diag([z_{i,j}]ⱼ₌₁^{K}^{ᵢ}),z_{i,j}˜Bernoulli(pᵢ) (2)

Where Pᵢ denotes the probability of random dropout of i^{th}-layer neuron connections, a matrix Mᵢ denotes a weight size, and when z_{i,j} is 0, it is indicated that a j^{th} neuron connection in an (i-1)^{th} layer is dropped.

Based on a deep Gaussian model, the embodiment of the present disclosure needs to make the estimated parameter posteriori distribution q(ω) close to the real parameter posteriori distribution p(ω|X,Y) as much as possible, that is, an optimization function of the deep Gaussian model is minimized KL(q(ω|X,Y)∥p(ω|X,Y)), and a specific derivation formula is shown as below:

$$\begin{matrix}ℒ = KL ( q ( ω \vert X , Y ) ‖ p ( ω \vert X , Y ) ) \\ = \int q ( ω \vert X , Y ) log q ( ω \vert X , Y ) - q ( ω \vert X , Y ) log p ( ω \vert X , Y ) d ω \\ = \int q ( ω \vert X , Y ) log q ( ω \vert X , Y ) - \\ q ( ω \vert X , Y ) log \frac{p ( ω ) p ( Y \vert X , ω ) p ( X \vert ω )}{P ( X , Y )} d ω \\ ∝ \int q ( ω \vert X , Y ) log q ( ω \vert X , Y ) - q ( ω \vert X , Y ) log p ( ω ) d ω - \\ \int q ( ω \vert X , Y ) log p ( Y \vert X , ω ) d ω \\ = - \int q ( ω \vert X , Y ) log p ( Y \vert X , ω ) d ω + KL ( q ( ω \vert X , Y ) ‖ p ( ω ) ) \\ \approx \frac{1}{N} {\sum }_{n = 1}^{N} - log p ( {y}_{n} \vert {x}_{n} , {\hat{ω}}_{n} ) + λ {\sum }_{i = 1}^{L} {‖ {θ}_{i} ‖}_{2}^{2}\end{matrix}$$

Where λ denotes a constant, and θ denotes a parameter weight of the neural network. It can be found through the above formula that an optimization process based on the Gaussian process is equivalent to a Dropout deep neural network with a cross-entropy loss function and L2 regularization. In other words, for the neural network with any depth and a nonlinear activation function, applying the Mc Dropout between the weighted layers is equivalent to the approximation of the deep Gaussian process.

On the basis of proof to obtain the above conclusion, the embodiment of the present disclosure can further prove that the model uncertainty can be acquired from the Mc Dropout-based deep neural network model. For a new input x*, a predicted output distribution estimated by the embodiment of the present disclosure is denoted by q(y*|x*), a priori predicted output distribution of the Mc Dropout-based deep neural network model is denoted by p(y*|x*,ω), and follows a normal distribution through Bayesian inference, and detailed formulas are shown as a following formula (3) and a following formula (4):

q(y*|x*)=∫p(y*|x*,ω)q(ω)dω (3)

p(y*|x*,ω)=N(y*;ŷ*(x*,ω),τ⁻¹I_{D}) (4)

Where ω denotes a parameter of the deep neural network model, τ denotes an accuracy rate parameter of the deep neural network model, and D denotes a dimension of an output y*. Based on the above distribution, a predicted mean of the input x* can be calculated through a following formula (5).

$$\begin{matrix}{E}_{q ( {y}^{*} \vert {x}^{*} )} ( {y}^{*} ) = \int {y}^{*} q ( {y}^{*} \vert {x}^{*} ) {dy}^{*} \\ = \int \int {y}^{*} p ( {y}^{*} \vert {x}^{*} , ω ) q ( ω ) d ω {dy}^{*} \\ \approx \frac{1}{T} {\sum }_{t = 1}^{T} {\hat{y}}^{*} ( {x}^{*} , {\hat{ω}}_{t} )\end{matrix} \qquad ( 5 )$$

Where T denotes a set of vectors {z^{t}|t=1,2 . . . T} based on bernoulli distribution. The practice has proved that the predicted distribution mean of the new input is equivalent to an average result obtained after performing T-time neural network forward propagation, and the neural network forward propagation is a forward processing process that the neural network model determines the output according to the input. As shown in a formula (6), in addition, a calculation formula of a prediction variance of the new input x* is shown as a following formula (7):

$$\begin{matrix}{E}_{q ( {y}^{*} \vert {x}^{*} )} ( {( {y}^{*} )}^{T} {y}^{*} ) = \int \int {( {y}^{*} )}^{T} {y}^{*} p ( {y}^{*} \vert {x}^{*} , ω ) q ( ω ) d ω {dy}^{*} \\ \approx \frac{1}{T} {\sum }_{t = 1}^{T} {{\hat{y}}^{*} ( {x}^{*} , {\hat{ω}}_{t} )}^{T} {\hat{y}}^{*} ( {x}^{*} , {\hat{ω}}_{t} ) + {τ}^{- 1} {I}_{D}\end{matrix} \qquad ( 6 )$$

$$\begin{matrix}{Var}_{q ( {y}^{*} \vert {x}^{*} )} ( {y}^{*} ) = \frac{1}{T} {\sum }_{t = 1}^{T} {{\hat{y}}^{*} ( {x}^{*} , {\hat{ω}}_{t} )}^{T} {\hat{y}}^{*} ( {x}^{*} , {\hat{ω}}_{t} ) + {τ}^{- 1} {I}_{D} - \\ {{E}_{q ( {y}^{*} \vert {x}^{*} )} ( {y}^{*} )}^{T} {E}_{q ( {y}^{*} \vert {x}^{*} )} ( {y}^{*} )\end{matrix} \qquad ( 7 )$$

It can be found through practice that the predicted distribution variance of the new input is equivalent to the sum of a variance obtained after T-time neural network forward propagation and the reciprocal of a model accuracy rate. In other words, in practical application, the multi-time neural network forward propagation can be directly performed without changing a training mode of the Mc Dropout-based deep neural network model to estimate the predicted mean for the input and uncertainty of the predicted mean by the neural network model.

It can be known from the above theoretical derivation that in order to introduce the model uncertainty required by the active learning, the embodiment of the present disclosure may use the Mc Dropout-based deep neural network model as the deep neural network model for detecting whether the indicator data is abnormal or not. When the Mc Dropout-based deep neural network model determines the detection results corresponding to the to-be-detected indicator data and the uncertainty of the detection results, the server can utilize the Mc Dropout-based deep neural network model to perform the multi-time neural network forward propagation on the to-be-detected indicator data, and thus, the detection results corresponding to the to-be-detected indicator data and the uncertainty of the detection results are determined according to detection results corresponding to the multi-time forward propagation.

As an example, the server can determine a detection result mean according to the detection results corresponding to the multi-time forward propagation. Then, the detection results corresponding to the to-be-detected indicator data are determined according to the detection result mean.

To facilitate understanding of the above implementation process of determining the detection results, the implementation process is exemplified below. Assuming that the deep neural network model used by the server is a three-layer deep neural network model, the number of neurons in a network structure in each layer is 50, and a random dropout rate of neuron connections is 0.02. For to-be-detected indicator data x*, the server can utilize the deep neural network model for performing 1000-time neural network forward propagation on the to-be-detected indicator data x*, and a corresponding abnormality score is obtained after each-time forward propagation. Since the inside neuron connections can be randomly dropped in the process of performing the forward propagation by the deep neural network model, the abnormality scores obtained after the multi-time forward propagation is performed on the to-be-detected indicator data x* are different. Then, the server can calculate a mean of the abnormality scores corresponding to the 1000-time forward propagation, and the score mean can be regarded as a detection result corresponding to the to-be-detected indicator data x*. If the score mean exceeds a preset score threshold, it can be considered that the to-be-detected indicator data x* is abnormal. By determining the detection result of the to-be-detected indicator data based on the detection result mean, influences brought by the randomly dropped neuron connections in the multi-time forward propagation can be comprehensively assessed when the detection result is determined, and thus, the determined detection result can more comprehensively represent advantages and disadvantages of the to-be-detected indicator data.

It is to be understood that in practical application, the server may also perform specific processing on the detection result mean besides directly using the detection result mean as the detection result corresponding to the to-be-detected indicator data, then, the processed data serves as the detection result corresponding to the to-be-detected indicator data, and the present disclosure does not limit a manner for determining the detection result corresponding to the to-be-detected indicator data based on the detection result mean.

As an example, the server can determine at least one of a detection result distribution variance and a detection result distribution standard deviation of detection results corresponding to multi-time forward propagation. Then, uncertainty of the detection result corresponding to the to-be-detected data is determined according to at least one of the detection result distribution variance and the detection result distribution standard deviation.

To facilitate understanding of the above implementation process of determining the uncertainty of the detection result, the implementation process is exemplified below. Assuming that the deep neural network model used by the server is the three-layer deep neural network model, the number of the neurons in the network structure in each layer is 50, and the random dropout rate of the neuron connections is 0.02. For the to-be-detected indicator data x*, the server may utilize the deep neural network model for performing 1000-time neural network forward propagation on the to-be-detected indicator data x*, and then abnormality scores corresponding to the 1000-time neural network forward propagation are obtained. Then, the server may calculate a variance of the abnormality scores corresponding to the 1000-time forward propagation to serve as the uncertainty of the detection result corresponding to the to-be-detected indicator data x*, or the server may also calculate a standard deviation of the abnormality scores corresponding to the 1000-time forward propagation to serve as the uncertainty of the detection result corresponding to the to-be-detected indicator data x*.

It is to be understood that in practical application, the server can perform specific processing on the detection result distribution variance or the detection result distribution standard deviation besides directly using the detection result distribution variance or the detection result distribution standard deviation as the uncertainty of the detection result corresponding to the to-be-detected indicator data, then, the processed data serves as the uncertainty of the detection result corresponding to the to-be-detected indicator data, and the present disclosure does not limit a manner for determining the uncertainty of the detection result based on the detection result distribution variance or the detection result distribution standard deviation.

In practical application, the above Mc Dropout-based deep neural network model specifically may be a deep Bayesian neural network model or a convolutional neural network model, and the present disclosure does not limit the model selection of the Mc Dropout-based deep neural network model.

Accordingly, the detection result corresponding to the to-be-detected indicator data and the uncertainty of the detection result are determined through the above Mc Dropout-based deep neural network model. The deep learning model can be better fused into the active learning process, which provides a reliable theoretical basis for realization of fusing the deep learning and the active learning, and provides an implementation for the deep learning model to generate the model uncertainty.

Operation 203: Select reference indicator data from the at least one to-be-detected indicator data according to the uncertainty of the detection result corresponding to each of the at least one to-be-detected indicator data, and acquire label detection results corresponding to the reference indicator data, where uncertainty of retrieved results corresponding to the reference indicator data is higher than uncertainty of detection results corresponding to non-reference indicator data in the at least one to-be-detected indicator data.

After determining, by the deep neural network model, the uncertainty of the detection results corresponding to the acquired at least one to-be-detected indicator data, the server can select the to-be-detected indicator data corresponding to the detection results high in uncertainty from the at least one to-be-detected indicator data according to the uncertainty of the detection result corresponding to each of the at least one to-be-detected indicator data to serve as the reference indicator data, and acquire the label detection results corresponding to the selected reference indicator data. Under normal conditions, the server may acquire a plurality of to-be-detected indicator data, and correspondingly, the server needs to select the reference indicator data from the plurality of to-be-detected indicator data at the time.

The selected reference indicator data is the to-be-detected indicator data corresponding to the detection results high in uncertainty, and it is hard for the deep neural network model to accurately detect whether the kind of reference indicator data is abnormal or not, that is, the detection capability of the deep neural network model on the kind of reference indicator data is poor at present. The label detection results corresponding to the reference indicator data are standard detection results corresponding to the reference indicator data. For example, the label detection results corresponding to the reference indicator data can be acquired in a manual labeling manner.

In a possible implementation, the server may select the reference indicator data from a following manner: Specific to each to-be-detected indicator data, whether the uncertainty of the detection result corresponding to the to-be-detected indicator data exceeds a preset threshold or not is judged, and if yes, the to-be-detected indicator data is determined as the reference indicator data. That is, the server can preset the preset threshold for measuring the degree of uncertainty, and then, specific to each to-be-detected indicator data, judges whether the uncertainty of its corresponding detection result exceeds the preset threshold or not; if yes, it is indicated that the detection result corresponding to the to-be-detected indicator data is unreliable, the deep neural network model has the poor processing capacity for the to-be-detected indicator data, and correspondingly, the server may regard the to-be-detected indicator data as the reference indicator data; and if not, it is indicated that the detection result corresponding to the to-be-detected indicator data is reliable, the deep neural network model has the high processing capacity for the to-be-detected indicator data, it is hard for the to-be-detected indicator data to greatly assist in optimized training of the deep neural network model, and thus, it is unnecessary to regard the to-be-detected indicator data as the reference indicator data.

In another possible implementation, the server may also select the reference indicator data by a following manner: The at least one to-be-detected indicator data is ranked according to a sequence of the uncertainty of the corresponding detection results from high to low. Then, a preset quantity of the to-be-detected indicator data ranking high is determined as the reference indicator data. That is, to avoid the high training cost in the active learning process, the server can arrange the plurality of to-be-detected indicator data according to the sequence of the uncertainty of the corresponding detection results from high to low, and then selects the plurality of to-be-detected indicator data most difficult for the deep neural network model to accurately process to serve as the reference indicator data in subsequent optimized training of the deep neural network model.

Of course, in practical application, the server may also adopt other manners to select the reference indicator data from the acquired at least one to-be-detected indicator data, and the present disclosure does not limit an implementation for selecting the reference indicator data.

According to the above introduction, the method provided by the embodiment of the present disclosure can be used for training the target indicator detection model with the cross-business scenario capability. In the situation, when acquiring the to-be-detected indicator data, the server needs to acquire the at least one to-be-detected indicator data from the plurality of target business scenarios, that is, specific to each target business scenario, the at least one to-be-detected indicator data is acquired. Correspondingly, when generating the detection results corresponding to the to-be-detected indicator data and the uncertainty of the detection results, the server may also, specific to each to-be-detected indicator data in each target business scenario, determine the uncertainty of its corresponding detection result. Correspondingly, when selecting the reference indicator data, the server also needs to equally treat the to-be-detected indicator data from the various target business scenarios, that is, the reference indicator data is selected from the at least one to-be-detected data in the various target business scenarios according to the uncertainty of the detection results corresponding to the plurality of to-be-detected data in the various target business scenarios.

That is, in the scenario where the target indicator detection model with the cross-business scenario capability is trained, when selecting the reference indicator data from the to-be-detected indicator data, the server may equally treat the to-be-detected indicator data in each target business scenario, mix the to-be-detected indicator data in the various target business scenarios, and select the reference indicator data from the mixed to-be-detected indicator data according to the uncertainty of the detection results corresponding to the to-be-detected indicator data without deliberately distinguishing the business scenarios.

Operation 204: Train the deep neural network model based on the reference indicator data and their corresponding label detection results, so as to obtain a target indicator detection model applicable to the target business scenarios.

After the server selects the reference indicator data from all the to-be-detected indicator data and acquires the label detection results corresponding to the reference indicator data, the reference indicator data and their corresponding label detection results can serve as feedback samples, and then, the feedback samples are utilized for performing the active learning (i.e., the optimized training) on the deep neural network model used in operation 202, so as to obtain the target indicator detection model for monitoring the indicator data in the target business scenarios.

The target indicator detection model is a model obtained after performing, by the selected feedback samples, the active learning on the deep neural network model, which has a good effect in the target business scenarios and can accurately detect whether the indicator data in the target business scenarios is abnormal or not. The target indicator detection model and the deep neural network model are the same in model structure, but are different in model parameter.

When specifically performing the active learning on the deep neural network model, the server can input the reference indicator data in the feedback samples into the trained deep neural network model, the deep neural network model analyzes and processes the reference indicator data, and then correspondingly outputs prediction detection results for the reference indicator data. Then, the server can construct, based on differences between the prediction detection results and the label detection results in the feedback samples, a loss function for training the deep neural network model, and adjust the model parameters of the deep neural network model with the goal of minimizing the loss function. The server may iteratively perform multi-round training on the deep neural network model based on the plurality of feedback samples until the deep neural network model satisfies a training end condition, and the deep neural network model satisfying the training end condition may be regarded as the target indicator detection model.

It is to be understood that the above training end condition may be a preset requirement that model performance of the deep neural network model satisfies, for example, detection accuracy of the model reaches a preset accuracy threshold, or is not obviously improved, or the like. The above training end condition may be an iterative training frequency for the deep neural network model reaching a preset frequency, which is not limited by the present disclosure.

It is to be understood that when the method provided by the embodiment of the present disclosure is used for training the target indicator detection model with the cross-business scenario capability, the server trains, based on the reference indicator data selected in operation 203 and their corresponding label detection results, the deep neural network model used in operation 202, and then obtains the target indicator detection model applicable to the plurality of target business scenarios, where the plurality of target business scenarios are business scenarios from which the to-be-detected indicator data acquired in operation 201 comes. Accordingly, the trained target indicator detection model can be used for detecting whether the indicator data in the plurality of target business scenarios is abnormal or not, which not only makes the target indicator detection model have a wide application range, but also expands the applicable business scenarios of the target indicator detection model.

Some embodiments of the present disclosure also provides an effective solution for the problem about concept drifts. The concept drifts refer to a phenomenon in which due to changes of a work mode in a business scenario, a distribution situation of indicator data required to be monitored in the business scenario changes. As shown in FIG. 4, along with changes of a work mode of a cloud server C, a distribution situation of a CPU utilization rate of the cloud server C also changes. In the related art, it is usually difficult for the indicator detection model trained based on the unsupervised learning manner to solve the above problem about the concept drifts, however, the embodiment of the present disclosure utilizes the characteristic that autonomic learning can rapidly optimize model performance with less label samples for effectively solving the above problem about the concept drifts.

Specifically, after detecting that the work mode in the target business scenario changes, the server can acquire at least one updated to-be-detected indicator data in the target business scenario with the changed work mode. Then, specific to each updated to-be-detected indicator data, uncertainty of a detection result corresponding to the updated to-be-detected indicator data is determined through the target indicator detection model. Then, updated reference indicator data is selected from the at least one updated to-be-detected indicator data according to the uncertainty of the detection result corresponding to each of the at least one updated to-be-detected indicator data, and label detection results corresponding to the updated reference indicator data are acquired. Finally, the target indicator detection model is trained based on the updated reference indicator data and their corresponding label detection results, so as to obtain an updated target indicator detection model applicable to the target business scenario with the changed work mode.

The solution for the problem about the concept drifts in the embodiment of the present disclosure is basically similar to the idea of the embodiment of the present disclosure for training the target indicator detection model applicable to the target business scenarios. That is, the updated reference indicator data difficult for the current target indicator detection model to accurately detect is selected from the updated to-be-detected indicator data in the target business scenario with the changed work mode, and then optimized training is performed on the current target indicator detection model based on the selected updated to-be-detected indicator data and their corresponding label detection results, such that the target indicator detection model can also accurately detect the indicator data in the target business scenario with the changed work mode. For a specific implementation process for the optimized training on the target indicator detection model, refer to related introduced contents in operations 201 to 204, and the implementation for the optimized training on the target indicator detection model is basically the same with the implementation for the optimized training on the deep neural network model, which is not repeated herein.

Accordingly, the embodiment of the present disclosure further uses the deep learning and active learning fused idea for solving the problem about the concept drifts. In the situation that the work mode of the target business scenario changes, the optimized training can be rapidly performed on the current existing target indicator detection model so as to obtain the updated target indicator detection model applicable to the target business scenario with the changed work mode, thereby improving indicator detection flexibility.

The above model training method creatively puts forward a mode of fusing deep learning and active learning to train the indicator detection model. Specifically, the method first utilizes the deep neural network model trained through the deep learning for determining the uncertainty of the detection results corresponding to the various to-be-detected indicator data. Then, feedback samples for the active learning are selected from the various to-be-detected indicator data according to the uncertainty of the detection results corresponding to the various to-be-detected indicator data. Then, the active learning is performed on the deep neural network model through the selected feedback samples to obtain the target indicator detection model applicable to the target business scenarios. Due to the uncertainty of the detection results corresponding to the to-be-detected indicator data generated by the deep neural network model, the degree of reliability of the detection results can be reflected, that is, the processing capacity of the deep neural network model on the to-be-detected indicator data can be reflected, and if the uncertainty is high, it is indicated that the processing capacity of the deep neural network model on the to-be-detected indicator data is poor, and it is hard to accurately detect whether the to-be-detected indicator data is abnormal or not. On that basis, the indicator data difficult for the deep neural network model to accurately detect can be selected from the to-be-detected indicator data according to the uncertainty of the detection result corresponding to each of the at least one to-be-detected indicator data in the embodiment of the present disclosure, and the indicator data and their corresponding label detection results are utilized as the feedback samples. The kind of feedback samples are high in quality, and the performance of the deep neural network model in the target business scenario can be rapidly improved only by utilizing a small number of the kind of feedback samples for training the deep neural network model, thereby achieving the effect of training the indicator detection model with the excellent performance with the low label cost.

To facilitate further understanding of the model training method provided by the embodiment of the present disclosure, training a target indicator detection model applicable to a game business scenario through the model training method is adopted as an example to integrally and exemplarily introduce the model training method.

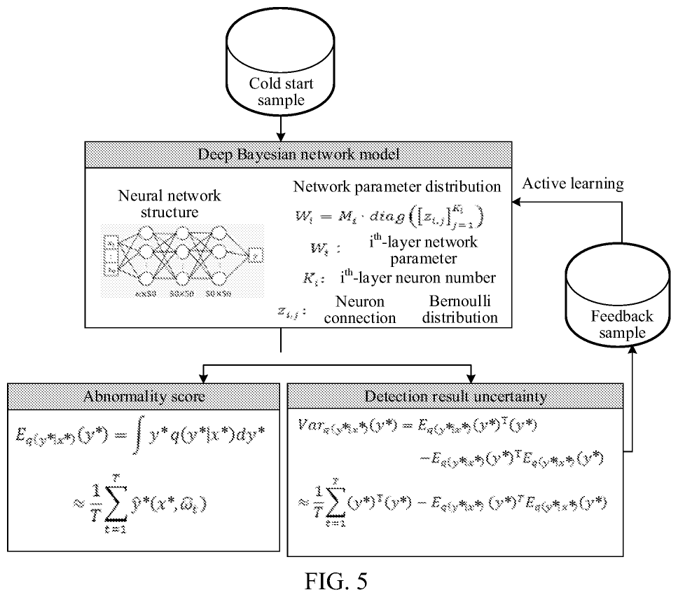

Refer to FIG. 5, and FIG. 5 is a schematic diagram of an implementation architecture for a model training method according to an embodiment of the present disclosure. As shown in FIG. 5, implementation of the model training method provided by the embodiment of the present disclosure is divided into two stages, one is an offline stage, and the other one is an online stage. In the offline stage, the server may train a deep Bayesian network model based on a cold start sample, and the deep Bayesian network model can be used for detecting whether observed indicator data is abnormal or not, that is, abnormality scores corresponding to the observed indicator data are detected, and uncertainty of detection results can be generated. The deep Bayesian network model specifically may be the random dropout neural network model in the embodiment shown in FIG. 2. In the online stage, the server may utilize the deep Bayesian network model for detecting to-be-detected indicator data in the game business scenario, select the to-be-detected indicator data corresponding to the detection results with high uncertainty from the to-be-detected indicator data according to the uncertainty of the detection results corresponding to the to-be-detected indicator data to serve as feedback samples, and then, utilize, in the active learning manner, the feedback samples for optimizing the deep Bayesian network model.

Assuming that in the offline stage, the server uses indicator data involved in a game business A and their corresponding label detection results for training the deep Bayesian network model for indicator detection. In the online stage, the server is about to utilize the deep Bayesian network model for detecting indicator data involved in a game business B. At the time, the server may utilize the deep Bayesian network model for detecting and processing the to-be-detected indicator data in the game business B to obtain detection results corresponding to the detected indicator data and uncertainty of the detection results, then, the server may screen out a small number of samples with high uncertainty from the indicator data based on the uncertainty of the detection results corresponding to the indicator data, and utilizes the part of samples for optimizing the deep Bayesian network model, such that the deep Bayesian network model has excellent detection performance in the game business B.

More specifically, when whether indicators are abnormal or not is detected, the server may select a three-layer deep Bayesian network model, the number of neurons in each layer is 50, and a random dropout rate of neuron connections is 0.02. For each to-be-detected indicator data x* in the game business B, the server may utilize the deep Bayesian network model for performing 1000-time neural network forward propagation, and calculates a mean of detection results of the 1000-time forward propagation to serve as an abnormality score of the indicator data x*. If the abnormality score exceeds a preset score threshold, it can be considered that the indicator data x* is abnormal. Compared with DONUT and DevNet in the related art, the abnormality detection result in the present disclosure has better F1-score, that is, the effect of the indicator detection method of the present disclosure is superior to that of other existing algorithms in the industry.

When predicted uncertainty of the deep Bayesian network model is extracted, the server may use a variance of the detection results of the 1000-time forward propagation to serve as the uncertainty of the detection result corresponding to the indicator data x*, and the server may use the uncertainty as the acquisition function of the active learning, and select indicator data corresponding to 200 detection results with highest uncertainty as feedback samples of the active learning. Then, optimized training is performed on the deep Bayesian network model based on the selected feedback samples to obtain a model applicable to detecting the indicator data involved in the game business B.

The inventor of the present disclosure tests the deep Bayesian network model of the present disclosure in the above scenario, one test implementation condition is to use the indicator data involved in the game business A to construct training samples of the deep Bayesian network model, then, the deep Bayesian network model is utilized for detecting the indicator data involved in the game business B, then, optimized training is performed on the deep Bayesian network model based on the method of the embodiment of the present disclosure, and a model obtained through the optimized training is utilized for detecting the indicator data involved in the game business B. The other test implementation condition is to use the indicator data involved in the game business B to construct training samples of the deep Bayesian network model, then, the deep Bayesian network model is utilized for detecting the indicator data involved in the game business A, then, optimized training is performed on the deep Bayesian network model based on the method of the embodiment of the present disclosure, and a model obtained through the optimized training is utilized for detecting the indicator data involved in the game business A.

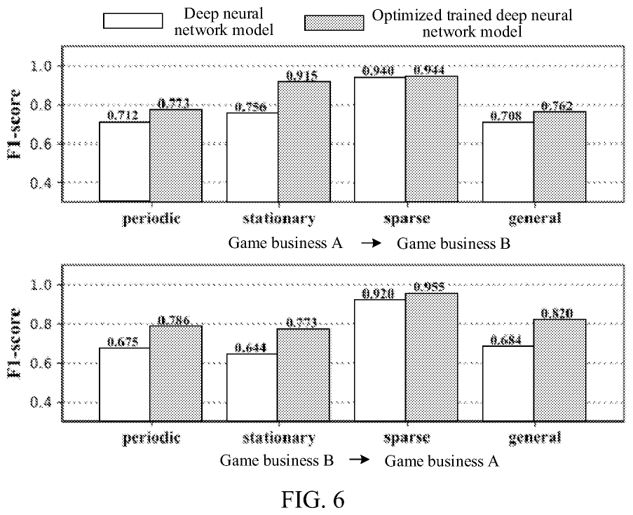

FIG. 6 illustrates, in two test situations, initial detection effects of the deep neural network model and detection effects after feedback samples are used for optimized training of the deep neural network model. Two models are used for respectively detecting a periodic KPI, a stationary KPI, a sparse KPI and a general KPI, which shows that the performance of the deep neural network model obtained after the optimized training is obviously improved. It is found through practice that 200 feedback samples are enough to effectively improve the online detect effect of the deep neural network model.

Specific to the above described model training method, the present disclosure further provides a corresponding model training apparatus, so as to make the above model training method applied and implemented in practice.

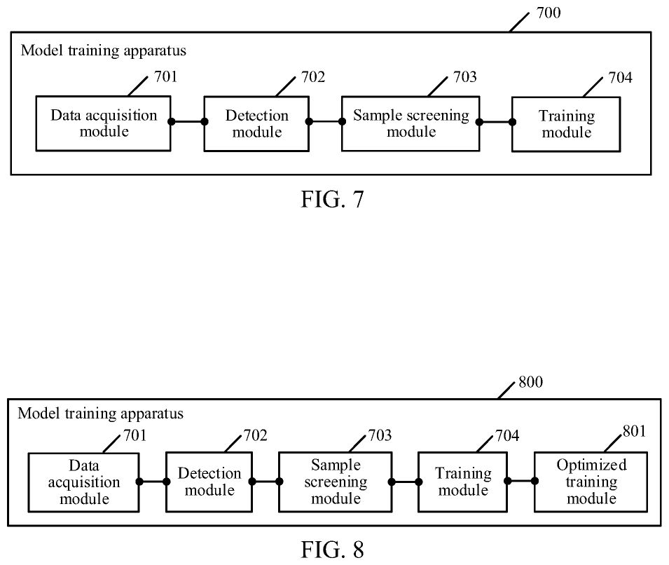

Refer to FIG. 7, and FIG. 7 is a structural schematic diagram of a model training apparatus 700 corresponding to the model training method shown in the above FIG. 2. As shown in FIG. 7, the model training apparatus 700 includes:
a data acquisition module 701 configured to acquire at least one to-be-detected indicator data in target business scenarios;
a detection module 702 configured to, specific to each to-be-detected indicator data, determine, by a deep neural network model, uncertainty of a detection result corresponding to the to-be-detected indicator data according to the to-be-detected indicator data, where the uncertainty is used for representing the degree of reliability of the detection results in the target business scenarios, and the detection results are determined by the deep neural network model according to the to-be-detected indicator data;
a sample screening module 703 configured to select reference indicator data from the at least one to-be-detected indicator data according to the uncertainty of the detection result corresponding to each of the at least one to-be-detected indicator data, and acquire label detection results corresponding to the reference indicator data, where uncertainty of retrieved results corresponding to the reference indicator data is higher than uncertainty of detection results corresponding to non-reference indicator data in the at least one to-be-detected indicator data; and
a training module 704 configured to train the deep neural network model based on the reference indicator data and their corresponding label detection results, so as to obtain a target indicator detection model applicable to the target business scenarios.

In some embodiments, the model training apparatus shown in FIG. 7, is a random dropout neural network model, and the random dropout neural network model, during operation, may randomly drop inside neuron connections based on a preset dropout rate. The detection module 702 may be configured to:
perform, by the random dropout neural network model, multi-time neural network forward propagation on the to-be-detected indicator data, so as to obtain detection results corresponding to the multi-time forward propagation; and
then, determine the uncertainty of the detection results corresponding to the to-be-detected indicator data according to the detection results corresponding to the multi-time forward propagation.
   In some embodiments, the detection module 702 may be configured to:
determine at least one of a detection result distribution variance and a detection result distribution standard deviation of the detection results corresponding to the multi-time forward propagation; and
determine the uncertainty of the detection results corresponding to the to-be-detected indicator data according to the at least one of the detection result distribution variance and the detection result distribution standard deviation.

In some embodiments, the detection module 702 may be further configured to:
determine a detection result mean according to the detection results corresponding to the multi-time forward propagation; and
determine the detection results corresponding to the to-be-detected indicator data according to the detection result mean.

In some embodiments, on the basis of the model training apparatus shown in FIG. 7, the sample screening module 703 may be configured to select reference indicator data by any following manner:

Specific to each to-be-detected indicator data, whether the uncertainty of the detection result corresponding to the to-be-detected indicator data exceeds a preset threshold or not is judged, and if yes, the to-be-detected indicator data is determined as the reference indicator data; or,
the at least one to-be-detected indicator data is ranked according to a sequence of the uncertainty of the corresponding detection results from high to low; and a preset quantity of the to-be-detected indicator data ranking high is determined as the reference indicator data.

In some embodiments, on the basis of the model training apparatus shown in FIG. 7, refer to FIG. 8, and FIG. 8 is a structural schematic diagram of another model training apparatus 800 according to an embodiment of the present disclosure. As shown in FIG. 8, the model training apparatus further includes: an optimized training module 801 configured to acquire at least one updated to-be-detected indicator data in the target business scenario with a changed work mode after it is detected that the work mode in the target business scenario changes;
specific to each updated to-be-detected indicator data, determine uncertainty of a detection result corresponding to the updated to-be-detected indicator data through the target indicator detection model;
select updated reference indicator data from the at least one updated to-be-detected indicator data according to the uncertainty of the detection result corresponding to each of the at least one updated to-be-detected indicator data, and acquire label detection results corresponding to the updated reference indicator data; and
train the target indicator detection model based on the updated reference indicator data and their corresponding label detection results, so as to obtain an updated target indicator detection model applicable to the target business scenario with the changed work mode.

In some embodiments, on the basis of the model training apparatus shown in FIG. 7, the data acquisition module 701 may be configured to:
determine a plurality of target business scenarios; and specific to each target business scenario, acquire at least one to-be-detected indicator data in the target business scenario.

The sample screening module 703 may be configured to:
select the reference indicator data from the at least one to-be-detected indicator data in the various target business scenarios according to the uncertainty of the detection result corresponding to each of the at least one to-be-detected indicator data in the various target business scenarios.

The training module 704 may be configured to:
train the deep neural network model based on the reference indicator data and their corresponding label detection results, so as to obtain a target indicator detection model applicable to the plurality of target business scenarios.

In some embodiments, on the basis of the model training apparatus shown in FIG. 7, the target business scenario may include any one of: the microservice monitoring scenario, the physical entity monitoring scenario, the logical entity monitoring scenario, the network topology monitoring scenario, or the log data monitoring scenario.

The above model training apparatus creatively puts forward a mode of fusing deep learning and active learning to train the indicator detection model. Due to the uncertainty of the detection results corresponding to the to-be-detected indicator data generated by the deep neural network model, the degree of reliability of the detection results can be reflected, that is, the processing capacity of the deep neural network model on the to-be-detected indicator data can be reflected, and if the uncertainty is high, it is indicated that the processing capacity of the deep neural network model on the to-be-detected indicator data is poor, and it is hard to accurately detect whether the to-be-detected indicator data is abnormal or not. On that basis, the indicator data difficult for the deep neural network model to accurately detect can be selected from the to-be-detected indicator data according to the uncertainty of the detection result corresponding to each of the at least one to-be-detected indicator data in the embodiment of the present disclosure, and the indicator data and their corresponding label detection results are utilized as the feedback samples. The kind of feedback samples are high in quality, and the performance of the deep neural network model in the target business scenario can be rapidly improved only by utilizing a small number of the kind of feedback samples for training the deep neural network model, thereby achieving the effect of training the indicator detection model with the excellent performance with the low label cost.

An embodiment of the present disclosure further provides a computer device for model training. The device specifically may be a terminal device or a server, and the terminal device and the server provided by the embodiment of the present disclosure are introduced in the aspect of hardware physicalization.

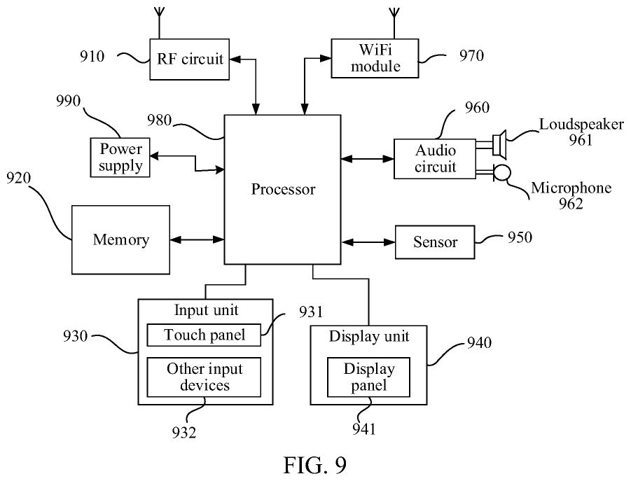

Refer to FIG. 9, and FIG. 9 is a schematic structural diagram of a terminal device according to an embodiment of the present disclosure. As shown in FIG. 9, for ease of description, only parts related to the embodiments of the present disclosure are shown. For specific technical details that are not disclosed, refer to the method part in the embodiments of the present disclosure. The terminal may be any terminal device such as a mobile phone, a tablet computer, a personal digital assistant, a point of sales (POS), and an on-board computer, and the terminal being the computer is adopted as an example.

FIG. 9 illustrates a block diagram of a part of structure of the computer related to the terminal according to the embodiment of the present disclosure. Referring to FIG. 9, the computer includes: a radio frequency (RF) circuit 910, a memory 920, an input unit 930 (including a touch panel 931 and other input devices 932), a display unit 940 (including a display panel 941), a sensor 950, an audio circuit 960 (which may be connected with a loudspeaker 961 and a microphone 962), a wireless fidelity (WiFi) module 970, a processor 980, a power supply 990, and other components. Those skilled in the art can understand that, the computer structure shown in FIG. 9 does not constitute a limit on the computer, and may include components that are more or fewer than those shown in the figure, or a combination of some components, or different component arrangements.

The memory 920 may be configured to store a software program and module. The processor 980 runs the software program and module stored in the memory 920, to implement various functional applications and data processing of the computer.

The processor 980 is a control center of the computer, and is connected to various parts of the entire computer by using various interfaces and lines. By running or executing the software program and/or module stored in the memory 920, and invoking data stored in the memory 920, the processor executes various functions of the computer and performs data processing.

In the embodiment of the present disclosure, the processor 980 included in the terminal further has the following functions:
acquiring at least one to-be-detected indicator data in target business scenarios;
specific to each to-be-detected indicator data, determining, by a deep neural network model, uncertainty of a detection result corresponding to the to-be-detected indicator data according to the to-be-detected indicator data, where the uncertainty is used for representing the degree of reliability of the detection results in the target business scenarios, and the detection results are determined by the deep neural network model according to the to-be-detected indicator data;
selecting reference indicator data from the at least one to-be-detected indicator data according to the uncertainty of the detection result corresponding to each of the at least one to-be-detected indicator data, and acquiring label detection results corresponding to the reference indicator data, uncertainty of retrieved results corresponding to the reference indicator data being higher than uncertainty of detection results corresponding to non-reference indicator data in the at least one to-be-detected indicator data; and
training the deep neural network model based on the reference indicator data and their corresponding label detection results, so as to obtain a target indicator detection model applicable to the target business scenarios.

In some embodiments, the processor 980 may be further configured to perform operations in any implementation of the model training method provided by the embodiment of the present disclosure.

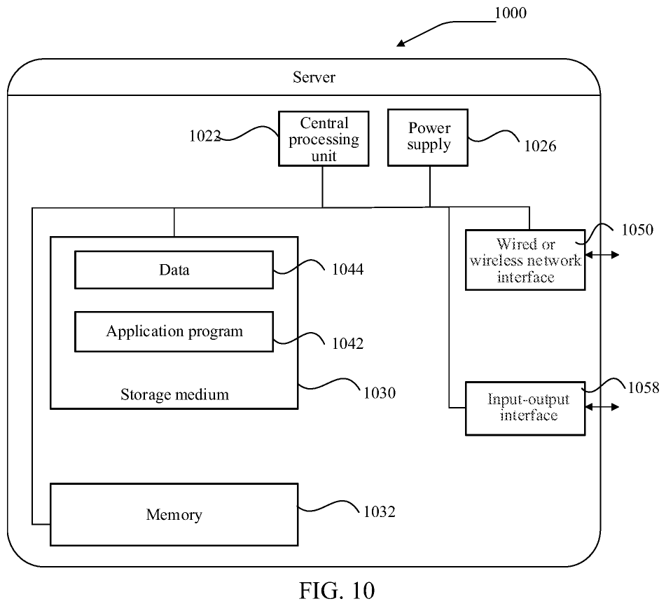

Refer to FIG. 10, and FIG. 10 is a schematic structural diagram of a server 1000 according to an embodiment of the present disclosure. The server 1000 may greatly differ as configuration or performance differs, may include one or more central processing units (CPUs) 1022 (e.g., one or more processors), a memory 1032, and one or more storage mediums 1030 storing an application program 1042 or data 1044 (e.g., one or more mass storage devices). The memory 1032 and the storage mediums 1030 may be used for transient storage or permanent storage. A program stored in the storage mediums 1030 may include one or more modules (which are not marked in the figure), and each module may include a series of instruction operations on the server. Further, the central processing units 1022 may be set to communicate with the storage mediums 1030, and perform, on the server 1000, the series of instruction operations in the storage mediums 1030.

The server 1000 may further include one or more power supplies 1026, one or more wired or wireless network interfaces 1050, one or more input/output interfaces 1058, and/or, one or more operating systems, such as Windows Server™, Mac OS X™, Unix™, Linux™, and FreeBSD™.

The operations performed by the server in the foregoing embodiment may be based on the server structure shown in FIG. 10.

The CPU 1022 is configured to perform the following operations:
acquiring at least one to-be-detected indicator data in target business scenarios;
specific to each to-be-detected indicator data, determining, by a deep neural network model, uncertainty of a detection result corresponding to the to-be-detected indicator data according to the to-be-detected indicator data, where the uncertainty is used for representing the degree of reliability of the detection results in the target business scenarios, and the detection results are determined by the deep neural network model according to the to-be-detected indicator data;
selecting reference indicator data from the at least one to-be-detected indicator data according to the uncertainty of the detection result corresponding to each of the at least one to-be-detected indicator data, and acquiring label detection results corresponding to the reference indicator data, uncertainty of retrieved results corresponding to the reference indicator data being higher than uncertainty of detection results corresponding to non-reference indicator data in the at least one to-be-detected indicator data; and
training the deep neural network model based on the reference indicator data and their corresponding label detection results, so as to obtain a target indicator detection model applicable to the target business scenarios.

In some embodiments, the CPU 1022 may be further configured to perform operations in any implementation of the model training method provided by the embodiment of the present disclosure.

An embodiment of the present disclosure further provides a computer-readable storage medium, used for storing a computer program. The program is used for performing any implementation in the model training method according to the foregoing embodiments.

An embodiment of the present disclosure further provides a computer program product or computer program, including computer instructions, and the computer instructions are stored in a computer-readable storage medium. The processor of the computer device reads the computer instructions from the computer-readable storage medium, and the processor executes the computer instructions, so that the computer device performs any implementation in the model training method according to the foregoing embodiments.

Those skilled in the art can clearly understand that for convenience and conciseness of description, for specific working processes of the foregoing described system, apparatus and unit, refer to the corresponding processes in the foregoing method embodiments, and details are not described herein again.

In the several embodiments provided in the present disclosure, it is to be understood that the disclosed system, apparatus, and method may be implemented in other manners. For example, the foregoing described apparatus embodiment is merely an example. For example, the unit division is merely a logical function division, and there may be other divisions during actual implementation. For example, a plurality of units or components may be combined or integrated into another system, or some features may be ignored or not performed. In addition, the displayed or discussed mutual couplings or direct couplings or communication connections may be implemented by some interfaces. The indirect couplings or communication connections between the apparatuses or units may be implemented in electrical, mechanical, or other forms.

The units described as separate components may be or may not be physically separated, and the components displayed as units may be or may not be physical units, and may be located in one place or may be distributed over a plurality of network units. Some or all of the units may be selected according to actual needs to achieve the objectives of the solutions of the embodiments.

In addition, functional units in the embodiments of the present disclosure may be integrated into one processing unit, or each of the units may be physically separated, or two or more units may be integrated into one unit. The integrated unit may be implemented in the form of hardware, or may be implemented in the form of a software functional unit.

When the integrated unit is implemented in the form of the software functional unit and sold or used as an independent product, the integrated unit may be stored in a computer-readable storage medium. Based on such an understanding, the technical solutions of the present disclosure essentially, or the part contributing to the related art, or all or some of the technical solutions may be implemented in the form of a software product. The computer software product is stored in a storage medium and includes several instructions for instructing a computer device (which may be a personal computer, a server, a network device, or the like) to perform all or some of the operations of the methods described in the embodiments of the present disclosure. The foregoing storage medium includes any medium that can store computer programs, such as a U disk, a mobile hard disk, a read-only memory (ROM), a random access memory (RAM), a magnetic disk, or an optical disc.

It is to be understood that, in the present disclosure, “at least one” means one or more, and “a plurality of” means two or more. “And/or” is used for describing an association relationship between associated objects and representing that there may be three relationships. For example, “A and/or B” may indicate: only A exists, only B exists, and both A and B exist, where A and B may be singular or plural. The character “/” generally indicates that the associated objects before and after it are in an “or” relationship. “At least one of the following items” or a similar expression means any combination of these items, including a single item or any combination of a plurality of items. For example, at least one of a, b or c may indicate: a, b, c, “a and b”, “a and c”, “b and c”, or “a, b, and c”, where a, b, and c may be singular or plural.

According to the above mentioned, the foregoing embodiments are merely used for describing the technical solutions of the present disclosure, but are not intended to limit the present disclosure. Although the present disclosure is described in detail with reference to the foregoing embodiments, those of ordinary skill in the art may understand that modifications may still be made to the technical solutions described in the foregoing embodiments, or equivalent replacements may be made to the part of the technical features; and such modifications or replacements do not cause the essence of the corresponding technical solutions to depart from the spirit and scope of the technical solutions of the embodiments of the present disclosure.

What is claimed is:

1. A method for optimizing training a deep neural network model, the method being executed by at least one processor, the method comprising:
acquiring at least one indicator data;
determining, by the deep neural network model, respective uncertainty of a detection result corresponding to respective indicator data among the at least one indicator data, wherein the respective uncertainty indicates a respective degree of reliability of the detection results;
selecting reference indicator data from the at least one indicator data based on the respective uncertainty of the detection result, wherein an uncertainty of the detection result corresponding to the reference indicator data is higher than the respective uncertainty of the detection result corresponding to non-reference indicator data among the at least one indicator data;
acquiring label detection results corresponding to the reference indicator data; and
obtaining a trained target indicator detection model based on training the deep neural network model based on the reference indicator data and the label detection results corresponding to the reference indicator data.

2. The method according to claim 1, wherein the deep neural network model is a random dropout neural network model, wherein the random dropout neural network model, during operation, randomly drops inside neuron connections based on a preset dropout rate; and
the determining of the respective uncertainty of a detection result corresponding respective indicator data comprises:
obtaining, by the random dropout neural network model, respective detection results based on multi-time forward propagation on the respective indicator data; and
subsequent to obtaining the respective detection results, determining the respective uncertainty of the detection results corresponding to the respective indicator data based on the respective detection results.

3. The method according to claim 2, wherein the determining of the respective uncertainty of the detection results subsequent to obtaining the respective detection results comprises:
determining at least one of a detection result distribution variance and a detection result distribution standard deviation of the respective detection results corresponding to the multi-time forward propagation; and
determining the respective uncertainty of the detection results corresponding to the respective indicator data based on the at least one of the detection result distribution variance and the detection result distribution standard deviation.

4. The method according to claim 3, the method further comprising:
determining a detection result mean based on the respective detection results corresponding to the multi-time forward propagation; and
determining the respective detection results corresponding to the respective indicator data based on the detection result mean.

5. The method according to claim 1, wherein the selecting the reference indicator data comprises at least one of:
based on a first uncertainty of the detection result corresponding to a first indicator data exceeding a preset threshold, selecting the first indicator data as the reference indicator data; or
ranking the respective uncertainty of the detection result corresponding to the respective indicator data from high to low, and selecting a preset quantity of indicator data ranking higher than a ranking threshold as the reference indicator data.

6. The method according to claim 1, the method further comprising:
acquiring at least one updated indicator data;
for respective updated indicator data, determining the respective uncertainty of a detection result corresponding to the respective updated indicator data based on the target indicator detection model;
selecting updated reference indicator data from among the at least one updated indicator data based on the respective uncertainty of the detection result corresponding to the respective updated indicator data;
acquiring label detection results corresponding to the updated reference indicator data; and
obtaining an updated target indicator detection model by training the target indicator detection model based on the updated reference indicator data and the label detection results corresponding to the updated reference indicator data.

7. The method according to claim 1, wherein the acquiring at least indicator data in comprises:
determining a plurality of target scenarios; and
acquiring the at least one indicator data for the plurality of target scenarios;
the selecting the reference indicator data comprises:
selecting the reference indicator data from the at least one indicator data for the plurality of target scenarios is based on the respective uncertainty of the detection result corresponding to the respective indicator data for the plurality of target scenarios; and
the obtaining the target indicator detection model comprises:
obtaining the target indicator detection model by training the deep neural network model based on the reference indicator data and label detection results corresponding to the reference indicator data.

8. The method according to claim 1, wherein the plurality of the target scenarios comprises one or more of: a microservice monitoring scenario, a physical entity monitoring scenario, a logical entity monitoring scenario, a network topology monitoring scenario, or a log data monitoring scenario.

9. An apparatus for optimizing training a deep neural network model, the apparatus comprising:
at least one first memory configured to store a first program code; and
at least one first processor configured to read the first program code and operate as instructed by the first program code, the first program code comprising:
first acquiring code configured to cause the at least one first processor to acquire at least one indicator data;
first determining code configured to cause the at least one first processor to determine, by the deep neural network model, respective uncertainty of a detection result corresponding to respective indicator data among the at least one indicator data, wherein the respective uncertainty indicates a respective degree of reliability of the detection results;
first selecting code configured to cause the at least one first processor to select reference indicator data from the at least one indicator data based on the respective uncertainty of the detection result, wherein an uncertainty of the detection result corresponding to the reference indicator data is higher than the respective uncertainty of the detection result corresponding to non-reference indicator data among the at least one indicator data;
second acquiring code configured to cause the at least one first processor to acquire label detection results corresponding to the reference indicator data; and
first obtaining code configured to cause the at least one first processor to obtain a trained target indicator detection model based on training the deep neural network model based on the reference indicator data and the label detection results corresponding to the reference indicator data.

10. The apparatus of claim 9, wherein the deep neural network model is a random dropout neural network model, wherein the random dropout neural network model, during operation, randomly drops inside neuron connections based on a preset dropout rate; and the first determining code comprises:
second obtaining code configured to cause the at least one first processor to obtain, by the random dropout neural network model, respective detection results based on multi-time forward propagation on the respective indicator data; and
subsequent to obtaining the respective detection results, second determining code configured to cause the at least one first processor to determine the respective uncertainty of the detection results corresponding to the respective indicator data based on the respective detection results.

11. The apparatus of claim 10, wherein the second determining code comprises:
third determining code configured to cause the at least one first processor to determine at least one of a detection result distribution variance and a detection result distribution standard deviation of the respective detection results corresponding to the multi-time forward propagation; and
fourth determining code configured to cause the at least one first processor to determine the respective uncertainty of the detection results corresponding to the respective indicator data based on the at least one of the detection result distribution variance and the detection result distribution standard deviation.

12. The apparatus of claim 11, wherein the first selecting data comprises:
fifth determining code configured to cause the at least one first processor to determine a detection result mean based on the respective detection results corresponding to the multi-time forward propagation; and
sixth determining code configured to cause the at least one first processor to determine the respective detection results corresponding to the respective indicator data based on the detection result mean.

13. The apparatus of claim 9, wherein the first selecting code comprises at least one of:
based on a first uncertainty of the detection result corresponding to a first indicator data exceeding a preset threshold, second selecting code configured to cause the at least one first processor to select the first indicator data as the reference indicator data; or
first ranking code configured to cause the at least one first processor to rank the respective uncertainty of the detection result corresponding to the respective indicator data from high to low, and selecting a preset quantity of indicator data ranking higher than a ranking threshold as the reference indicator data.

14. The apparatus of claim 9, the program code further comprising:
second acquiring code configured to cause the at least one first processor to acquiring at least one updated indicator data;
for respective updated indicator data, seventh determining code configured to cause the at least one first processor to determine the respective uncertainty of a detection result corresponding to the respective updated indicator data based on the target indicator detection model;
third selecting code configured to cause the at least one first processor to select updated reference indicator data from among the at least one updated indicator data based on the respective uncertainty of the detection result corresponding to the respective updated indicator data;
third acquiring code configured to cause the at least one first processor to acquire label detection results corresponding to the updated reference indicator data; and
third obtaining code configured to cause the at least one first processor to obtain an updated target indicator detection model by training the target indicator detection model based on the updated reference indicator data and the label detection results corresponding to the updated reference indicator data.

15. A non-transitory computer-readable storing instructions that cause at least one processor to:
acquire at least one indicator data;
determine, by the deep neural network model, respective uncertainty of a detection result corresponding to respective indicator data among the at least one indicator data, wherein the respective uncertainty indicates a respective degree of reliability of the detection results;
select reference indicator data from the at least one indicator data based on the respective uncertainty of the detection result, wherein an uncertainty of the detection result corresponding to the reference indicator data is higher than the respective uncertainty of the detection result corresponding to non-reference indicator data among the at least one indicator data;
acquire label detection results corresponding to the reference indicator data; and
obtain a trained target indicator detection model based on training the deep neural network model based on the reference indicator data and the label detection results corresponding to the reference indicator data.

16. The non-transitory computer-readable medium of claim 15, wherein the deep neural network model is a random dropout neural network model, wherein the random dropout neural network model, during operation, randomly drops inside neuron connections based on a preset dropout rate; and
the determining of the respective uncertainty of a detection result corresponding respective indicator data comprises:
obtaining, by the random dropout neural network model, respective detection results based on multi-time forward propagation on the respective indicator data; and
subsequent to obtaining the respective detection results, determining the respective uncertainty of the detection results corresponding to the respective indicator data based on the respective detection results.

17. The non-transitory computer-readable medium of claim 16, wherein the determining of the respective uncertainty of the detection results subsequent to obtaining the respective detection results comprises:
determining at least one of a detection result distribution variance and a detection result distribution standard deviation of the respective detection results corresponding to the multi-time forward propagation; and
determining the respective uncertainty of the detection results corresponding to the respective indicator data based on the at least one of the detection result distribution variance and the detection result distribution standard deviation.

18. The non-transitory computer-readable medium of claim 17, the instructions further causing the at least one processor to:
determine a detection result mean based on the respective detection results corresponding to the multi-time forward propagation; and
determine the respective detection results corresponding to the respective indicator data based on the detection result mean.

19. The non-transitory computer-readable medium of claim 15, wherein the selecting the reference indicator data comprises at least one of:
based on a first uncertainty of the detection result corresponding to a first indicator data exceeding a preset threshold, selecting the first indicator data as the reference indicator data; or
ranking the respective uncertainty of the detection result corresponding to the respective indicator data from high to low, and selecting a preset quantity of indicator data ranking higher than a ranking threshold as the reference indicator data.

20. The non-transitory computer-readable medium of claim 15, the instructions further causing the at least one processor to:
acquire at least one updated indicator data;
for respective updated indicator data, determine the respective uncertainty of a detection result corresponding to the respective updated indicator data based on the target indicator detection model;
select updated reference indicator data from among the at least one updated indicator data based on the respective uncertainty of the detection result corresponding to the respective updated indicator data;
acquire label detection results corresponding to the updated reference indicator data; and
obtain an updated target indicator detection model by training the target indicator detection model based on the updated reference indicator data and the label detection results corresponding to the updated reference indicator data.
